(19) United States
(12) Patent Application Publication
(10) Pub. No.: US 2010/0274645 A1
(43) Pub. Date: Oct. 28, 2010

(54) System and method for providing user directed advertisements over a network

(76) Inventors: Paul Trevithick, Chestnut Hill, MA (US); Drummond Reed, Seattle, WA (US); Markus Sabadello, Vienna (AT); Thomas Carroll, Norwood, MA (US); John Bradley, Cultus Lake (CA); Brian Walker, Holden, MA (US)

Correspondence Address: Iandiorio Teska & Coleman, 260 Bear Hill Road, Waltham, MA, 02451, US

(21) Appl. No.: 12/590,679

(22) Filed: Nov. 12, 2009

Related U.S. Application Data
(60) Provisional application No. 61/198,916, filed on Nov. 12, 2008.

(51) Int. Cl. G06Q 30/00

(52) U.S. Cl. 705/14.5; 705/14.49; 705/14.61

(57) ABSTRACT

A user directed advertisement network includes an ad server having a database for storing advertisements from one or more vendors, and a broker configured with software to receive and store claims including information of advertisement preferences of a principal, and based upon at last one claim to provide to the principal one or more advertisements stored on the ad server that relate to the preferences of the principal. An agent used by the principal and configured with software to provide the claims including the information of the advertisement preferences to the broker, and to receive the advertisements from the broker.

### RELATED APPLICATIONS

This application hereby claims the benefit of and priority to U.S. Provisional Application Ser. No. 61/198,916, filed on Nov. 12, 2008, under 35 U.S.C. §§119, 120, 363, 365, and 37 C.F.R. §1.55 and §1.78, and which is incorporated herein by reference.

### FIELD OF THE INVENTION

The subject invention relates to advertisements that are provided over a network.

### BACKGROUND OF THE INVENTION

At the present time, advertising and other forms of vendor-sponsored messages, collectively referred to herein as “sponsored messages”, are delivered to users of web browsers or other viewing software (“principals”) over the Internet or other networks. Sponsored messages are inserted into web pages as directed by the HTML markup or client-side JavaScript of page authored by the website (“site”). Advertisers, referred to herein as “sponsors”, may purchase ad space directly from the site. In current practice many sites also outsource the selection and delivery of at least a portion of their space for sponsored messages to Web advertising networks, referred to herein as “ad networks”, from whom sponsors purchase ad packages.

This overall network of relationships for delivering sponsored messages is suboptimal because in almost every case site, ad networks, or sponsors, collectively referred to herein as “vendors”, have dramatically less knowledge than the principal about which sponsored messages are most interesting, relevant, and useful to the principal. In current practice many vendors try to solve this problem by finding ways to accumulate more knowledge about the principal. However this approach has several serious drawbacks.

First, it raises privacy concerns, as widely documented in the press, because a detailed profile of the principal is being assembled by vendors outside of the knowledge or control of the principal.

Second, it requires that the principal disclose information about themselves, their interests, and their intentions to vendors either manually, such as filling out forms, or automatically, by tracking the principal's actions using their browser or other software/services (such as loyalty cards) on the Internet or other networks. The former is bothersome and repetitive for the principal; the latter represents further privacy intrusion.

Thirdly, no single vendor is capable of aggregating all knowledge about a principal, let alone about a principal's current context or intentions at the time the principal is viewing sponsored messages. Only the principal, or an immediate delegated trusted agent acting on behalf of the principal, is in such a position.

Attempts to solve this problem have taken several approaches including: 1) Inserting intermediary servers operating between the site and the principal's browser, such as a proxy server; 2) Installing an alternate user agent operating locally on the principal's machine, such a browser extension or standalone advertising program, to deliver “pushed” content; and 3) Installing browser extensions for ad blocking.

An example of the first approach described above is the Adzilla service that was operated for cable companies and DSL providers. The service was recently shut down due to both lack of consent from the Principal and violation of the site's copyright on the Web pages it delivers to the Principal's browser (because the pages were modified prior to receipt by the Principal).

An example of the second approach described above is the London, UK-based Skinkers live notification platform. This solution delivers targeted content and sponsored messages, but operates as a dedicate program that requires its own independent screen real estate and serves only a narrow, self-selected audience. An earlier example dating to the dotcom days was the original PointCast “push” application.

An example of the third approach is the AdBlock Firefox plugin. Utilities like this give a principal control over their browser screen real estate but only for the purpose of blocking sponsored messages, not otherwise controlling or directing their content. While ad blocking software illustrates the ultimate control a principal may exert over their own user agent behaviour, simply blocking all sponsored messages does not solve the problem because it does not enable a permissioned communications channel between the sponsor and the principal to deliver messages of real value to both a sponsor and a principal with minimal effort on each of their parts. Ad blocking also erodes or destroys the revenue model for the sites that are based on an advertising business model.

### BRIEF SUMMARY OF THE INVENTION

It is therefore an object of this invention to provide a user directed ad network that enables vendors to deliver sponsored messages to principals who will find them relevant and interesting.

It is a further object of this invention to provide such a user directed ad network in which the content of the advertisements are directed by the principal.

It is a further object of this invention to provide such a user directed ad network which respects the privacy of the principal and does not need to release their personal information.

It is a further object of this invention to provide such a user directed ad network which provides incentives for both the principal and existing ad networks to participate in using the network.

The subject invention, however, in other embodiments, need not achieve all these objectives and the claims hereof should not be limited to structures or methods capable of achieving these objectives.

This invention results from the realization that it is more effective to have a principal direct the content of advertising that the principal receives by providing to a broker one or more claims that include information of the principal's advertisement preferences so that the broker may provide the principal with relevant advertisements that relate to the advertisement preferences of the principal.

This invention features a user directed advertisement network which includes an ad server having a database for storing advertisements from one or more vendors, a broker configured with software to receive and store claims including information of one or more advertisement preferences of a principal, and based upon at least one claim to provide to the principal one or more advertisements stored on the ad server that relate to the preferences of the principal, and an agent used by the principal and configured with software to provide the claims including the information of the advertisement preferences to the broker, and to receive the advertisements from the broker.

In one embodiment, the network may include one or more cards having information relating to the advertisement preferences of a principal. The claims may include rules relating to the advertisement preferences of a principal. The agent may include a selector. The agent may include a browser extension program that runs on the selector. The agent may include a program that is an extension to another local program. The agent may include a standalone client-side program. A third-party may also provide one or more cards that include information of advertisement preferences of the principal to the broker. The information of the advertisement preferences of the principal may include information about the principal. The information of the advertisement preferences of the principal may include specific products or services from a wishlist of the principal. The network may include an accounting server for tracking the number of times a principal clicks on an advertisement of a vendor. The principal may be paid for clicking on advertisements. The broker may be further configured with software to use knowledge based authentication (KBA) to prevent gaming of the advertisement network. The broker may receive feedback from the principal regarding the types of advertisement that the principal would like to receive. The feedback may include information that the principal would like to receive more advertisements like an advertisement that the principal has already received. The feedback may include an indication that the principal would like to receive more specific information about an advertisement. The feedback may include an indication that the principal would like to enter into a relationship directly with the vendor of a specific advertisement. The feedback may include an indication that the principal would like more specific information from the vendor. The agent may communicate with the ad server via an XDI communications protocol. The user directed advertisement network may receive the revenue from displaying the advertisements and the website that displays the advertisement may not receive any revenue from the advertisement. The user directed advertisement network may use an auction for the pricing of advertisements. The broker may be configured to use a dictionary service to provide a common vocabulary between the information of the advertisement preferences of the principal and information about the advertisements. The broker may provide advertisements to the principal further based upon a current context of the principal. The current context may be a current web page that the principal is browsing. The current context may be a current time. The current context may be a current weather. The broker may provide advertisements to the principal further based upon the inventory of advertisements stored on the ad server. The broker may be provided by a web service. The broker may be co-resident with the user agent.

This invention also features a method for directing advertisements to a user over a network, the method which includes storing advertisements from one or more vendors, receiving and storing claims including information of one or more advertisement preferences of a principal, and based upon at least one claim, providing to the principal over the network advertisements that relate to the preferences of the principal.

In another embodiment, the method may include receiving feedback from the principal regarding the types of advertisement that the principal would like to receive. The method may include tracking the number of times a principal clicks on an advertisement of a vendor. The method may include paying the principal for clicking on advertisements. The method may include using knowledge based authentication (KBA) to prevent gaming of the advertisement network. The claims may include one more cards each having information of the advertisement preferences of a principal. The claims may include one or more rules relating to advertisement preferences of a principal. The advertisements provided to the principal may be further based upon a current context of the principal. The current context may be a current web page that the principal is browsing. The current context may be a current time. The current context may be a current weather. The advertisements provided to the principal may be further based upon the inventory of advertisements.

This invention also features a user directed advertisement network which includes means for storing advertisements from one or more vendors, a broker configured with software to receive and store claims including information of one or more advertisement preferences of a principal, and to provide to the principal one or more advertisements stored on the ad server that relate to the preferences of the principal, and means used by the principal and configured with software to provide the claims including the information of the advertisement preferences to the broker, and to receive the advertisements from the broker.

In another embodiment, the claims may include one or more cards having information relating to the advertisement preferences of a principal. The claims may include rules relating to the advertisement preferences of a principal.

This invention also features a method for directing advertisements to a user over a network, the method includes configuring a broker with software to receive and store claims including information of one or more advertisement preferences of a principal, and to provide to the principal one or more advertisements stored on an ad server that relate to the preferences of the principal, and configuring an agent used by the principal with software to provide the claims including the information of the advertisement preferences to the broker, and to receive the advertisements from the broker.

In another embodiment, claims may include one or more cards having information relating to the advertisement preferences of a principal. The claims may include rules relating to the advertisement preferences of a principal.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram showing the primary components associated with a user directed advertisement network in accordance with an example of the subject invention;

FIG. 2 is a block diagram showing the primary components associated with a typical selector depicted in FIG. 1;

FIG. 3 is a block diagram illustrating the primary components associated with a typical broker depicted in FIG. 1;

FIG. 4 is a block diagram depicting the primary components associated with a typical party shown in FIG. 1;

FIG. 5 is a screen shot of a user interface for the system of FIG. 1; and

FIG. 6 is a flow diagram of a sequence for directing advertisements to a user over a network.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

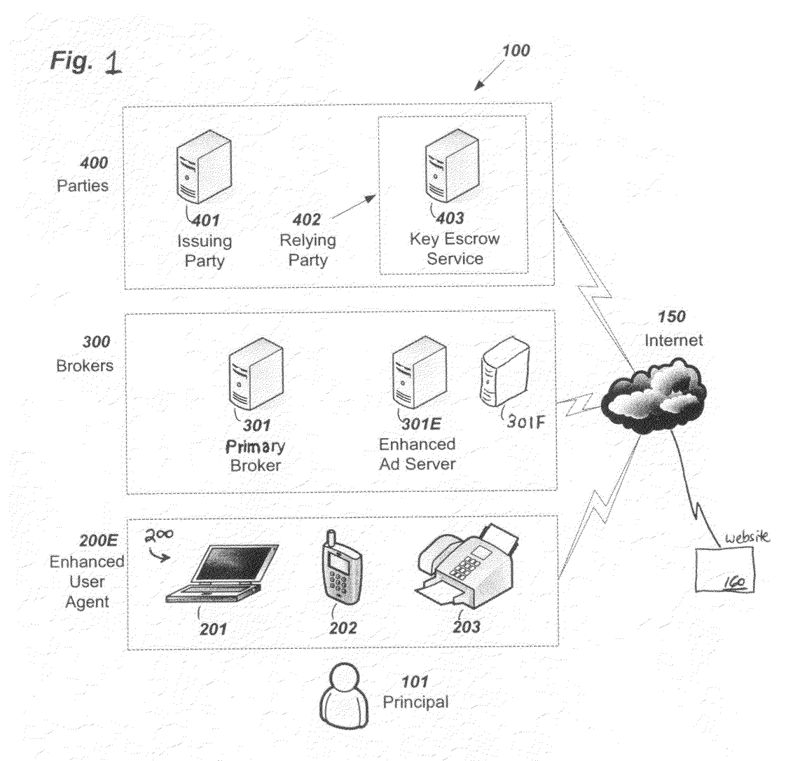

FIG. 1 illustrates one example embodiment of a system for providing user directed advertisements over a network. System 100 operating on behalf of principal 101 includes a set of selectors 200, one or more brokers 300 such as a primary broker 301, and parties 400. All of these components can communicate with one another over one more networks such as the Internet 150. Such communications could also take place over the phone network, satellite networks, or any other network capable of data communications. The type of communications network is not a limiting feature of the invention.

Principal 101 communicates and interacts with the other components using a selector 200 operating on devices such as laptop computer 201, smart phone 202, and smart fax machine 203. With the present invention, a principal is not limited to using a single selector operating on a single device, but may use any number of selectors operating on any number of devices, all of which may provide access to and control of the principal's account(s) in system 100.

Although it may run on a server, selector 200 is typically a client software program running on a local device that communicates with servers operating online over Internet 150 or other communications networks. Selector 200 may also store a set of provisioning information, including identifiers, credentials, keys, and service endpoints, for controlling access to system 100 and authenticating to brokers 300.

With system 100, a principal 101 directs the delivery of sponsored messages to the principal's browser or other content viewing application by use of a special user agent, referred to herein as an “enhanced user agent” and a broker 301 acting on behalf of the principal instead of the site 160 being browsed (or on the interests of any particular vendor). System 100 does not require that the sponsored messages take any new screen real estate (although with the principal's permission this is an option). Instead, sponsored messages may appear directly in place of existing advertising banners or other sponsored messages currently appearing on web pages from site 160. The broker(s) offering such a service and the set of principals they serve constitutes a new form of Internet advertising network, referred to herein as a user directed advertisement network (UDAN).

A user directed advertisement network may be distinguished from a conventional Internet ad network by certain characteristics. For example, ad content is user driven. Instead of advertising being delivered to the principal 101 by a site, it is delivered to the principal via their own enhanced user agent, which may be implemented as an extension to principal's browser as described below. This enhanced user agent, working in conjunction with a special ad server referred to herein as a “enhanced ad server” operated by the broker 301, delivers sponsored messages exclusively based on the principal's interest in products, services, companies, brands, topics (collectively referred to herein as “principal profile information”—any information about the principal 101 that the principal chooses to use to control their receipt of sponsored messages). Such interests may be either expressed explicitly by the principal using claims from special information cards (“principal profile cards”), or inferred by the enhanced user agent or the broker 301 based on claims from rules entered/approved by the principal (referred to herein as “principal rules”).

In a user directed ad network, users typically control the disclosure of information about them. The broker 301 protects the principal's privacy because the principal profile information necessary to deliver the highest value sponsored messages to the principal is preferably only shared between the enhanced user agent and the enhanced ad server. It does not need to be shared with a vendor, and in a preferred embodiment is not even shared in an identifiable form with the broker. Since the broker's UDAN “ad inventory” is the screen real estate of principals served by the broker, the broker is heavily incented to protect the principal's privacy as directed by the principal.

With the subject invention, ad space is preferably sold by brokers representing principals 101 instead of sites. In conventional Internet advertising models, sponsors buy ad space or click-throughs either directly from sites or from an ad network that purchases from sites. In a user directed ad network 100, sponsors, ad networks, and sites all buy space or click-throughs from brokers acting on behalf of the principals they serve. This enables the development of entirely new business models and value chains that better align the incentives of all parties and result in both a more efficient and higher quality marketplace.

Enhanced User Agent 200E software component controls display of sponsored messages within the principal's browser or elsewhere within the principal's computing display environment. Typically an enhanced user agent will be implemented as a browser extension that works in conjunction with the selector 200. However, it may also be implemented as part of the selector, as an extension to another local program, or as a standalone client-side program. It may also be a new function built directly into a browser program or into hardware on a device with Web access.

System 100 may also enable principal 101 to easily and safely form information sharing relationships with parties 400. FIG. 1 illustrates two primary types of parties: issuing parties 401 and relying parties 402. Parties 400 may also serve as service providers to principal 101. For example, a key escrow service 403 may act as relying party 402. These roles are distinguished by the directionality of their information sharing relationship with the principal as explained above. In three-way information sharing relationships, each party plays only one role: the issuing party issues the shared information, the principal selects the information to be shared and the relying party with which to share it, and the relying party receives the shared information. These relationships are described in more detail in U.S. patent application Ser. No. 10/080,878, filed Feb. 22, 2002, herein incorporated by reference.

Principal Profile Cards are cards that provide any set of claims that enable the principal 101 to direct and control the content, delivery, or actions associated with sponsored messages. These cards may be principal cards or third-party cards. They may describe any aspect of the principal 101 including contact information, demographics, psychographics, educational history (schools, universities, degrees, subjects), professional credentials, product/service histories, brand preferences, affiliations, consumer preferences of any kind (food, clothing, travel, communications, customer service, etc.), financial information (banking, credit cards, insurance, investments, brokers, etc.), interests, hobbies, goals, intents, contexts, circumstances, ratings, scores, reputations, etc.

A group of one or more claims together with metadata describing this set of claims is referred to herein as a card. The term “card”, also referred to in the industry as “information card”, “infocard”, or “i-card”, derives both from the grouping of claims into a set and from the ability for a user interface to present this set to the principal (or other parties) using the metaphor of a physical card such as a library card, business card, driver's license card, credit card, etc. However this metaphor does not limit the actual data structure; a card may be any structured digital object capable of transferring claims, claims metadata, and other associated information between two or more parties on a network. Cards, claims, claims authorities, claims transformers, and related art are described generally in: “Personal Identification Information Schemas”, U.S. Patent Application Publication US 2007/0204325 A1, Kim Cameron and Arun Nanda, Aug. 30, 2007, incorporated by reference herein.

Wish Cards are a special type of principal profile card that expresses specific products or services on a principal's wishlist. Wish cards may be for a general class of product or service, or they may be specific to a particular product or service, and may even go into detailed requirements for that product or service (a “personal RFP”). They may also capture a principal's intent or wish with respect to a specific goal, i.e., “I wish to receive this product for my birthday”, “I wish to buy this product for my mother”, “I wish to move to Cleveland”.

Principal Rules are rules or rulesets designated by the principal 101 to enhance the effectiveness of principal profile cards, including wish cards. Principal rules may be integrated directly with principal profile cards, stored on separate principal rule cards, or communicated directly between the enhanced user agent and the enhanced ad server. Example principal rules are, “Do not show me advertisements for automobiles,” “Do not show me animated advertisements,” “Do not show this Wish Card to my wife,” or “This Wish Card expires at Christmas.”

Enhanced ad server 301E is a server operated by a broker 301 or an agent of the broker 301 that operates similarly to a conventional ad server, except that it contains additional functionality for brokering the relationship between the principal 101 and the vendors who want to deliver sponsored messages. Primary broker 301 is shown as having a separate server than ad server 301E but this is not a limitation of the invention since broker may use only one server. The additional functionality of ad server 301E includes: a) serving as a relying party for principal profile cards and principle rules to accept claims from principals to direct delivery of sponsored messages, b) accepting orders from vendors who wish to match sets of claims and rules in order to deliver specific sponsored messages, and c) performing matching between (a) and (b) to deliver the optimal set of sponsored messages to principals at the optimal time. Another key difference between a conventional ad server and an enhanced ad server is that the latter may also deliver sponsored messages to principals, subject to the principal's permissions and preferences, via other channels in addition to the enhanced user agent, such as via email, instant messaging, fax messages, or even postal mail.

Accounting Server 301F is an optional function integrated with or operating independently from the enhanced ad server that includes a database for tracking of sponsored message click-throughs and related enhanced user agent actions in order to providing accounting to the UDAN.

In the general operation of a UDAN, the principal 101 obtains and installs the enhanced user agent from the broker 301 or a partner of the broker 301. In a preferred embodiment the enhanced user agent is packaged and delivered with a selector, but it may also be downloaded and installed separately.

The enhanced user agent may begin directing delivery of sponsored messages for the principal 101 immediately based only on whatever principal profile information was initially entered to register as a customer of the broker 301. However in a preferred embodiment the selector prompts the principal to enter claims that may include cards, such as principal profile cards (and optionally wish cards), and/or principal rules which include information about advertising preferences. The principal may also select claims from other cards to be used (directly or anonymized) as principal profile information to assist in directing sponsored messages. Note that the use of cards is not strictly required; such principal profile information may also be entered directly into the selector or enhanced user agent.

The enhanced user agent begins communicating with the enhanced ad server via a communications protocol such as XDI to deliver principal profile information from the sources described above to the enhanced ad server. Selected claims or all claims may be anonymized to protect the principal's privacy, however, principal information at the enhanced ad server does not need to be released to vendors or any other third party. The enhanced ad server processes and indexes these claims so that it can optimally match principals with sponsored messages from vendors.

Vendors purchase ad space from the UDAN and deliver sponsored messages (or make them available) to the enhanced ad server for matching with principals. Each sponsored message is preferably associated with matching criteria for determining the optimal principal match. This associated matching criteria is referred to herein as a “sponsored message profile”.

When the principal 101 loads a web page or any other resource for which the default settings for the enhanced user agent (or in one embodiment the principal's rules) indicate the principal should receive a sponsored message, the enhanced user agent requests a sponsored message from the enhanced ad server. The enhanced ad server determines the optimal match and returns the selected sponsored message to the enhanced user agent for display to the principal.

If sponsored messages are sold on the basis of successful click-throughs, the sponsored message contains a link back to the accounting server 301F for click-through tracking purposes. The account server then redirects the principal's browser to the destination specified by the sponsor. Alternatively, the enhanced user agent may have a means of recording clicks on advertising links that go directly to the intended destination. The agent would then notify the accounting server.

The enhanced ad server and/or accounting server tracks the sponsored messages delivered and click-throughs received and either communicates the delivery reports to the broker 301 and/or overall UDAN operator for billing to the vendor, or performs such billing directly.

In the above description, the broker receives the ad preferences from the principal, and then decides which ads to server based on those preferences. The broker, however, may also consider other information to provide the most relevant advertisements to the principal. For example, the broker may consider the current state of the principal—where are they, what web page are they looking at, what time of day is it, what is the weather, etc. The broker may triangulate between three sets of data—the principal's preferences, the principal's current context, and the ad inventory—in order to provide relevant advertising. For example, the principal may obtain a “New England Patriots Fan Card”, and load it into his UDAN-agent. If the principal is browsing the Williams-Sonoma web site, the principal may be offered a Patriots logo Apron+Pot Holder set, while if browsing the ESPN web site reading an article about World Cup Skiing, the principal may be offered a Patriots logo Ski Hat+Gloves package. Even though both fit the principal's expressed preference of “Patriots Fan”, neither would be particularly relevant in the other context.

The design of a UDAN, where the principal 101 is an active participant in directing the type of sponsored messages he/she receives, enables a much richer and more effective range of feedback functions than conventional advertising networks where the principal 101 is simply a passive observer of messages selected/delivered by vendors. These feedback functions will be referred to herein as “principal feedback functions”.

For example, such principal feedback functions may be standardized for all sponsored messages in a user directed ad network. Such functions would be supported by all enhanced user agents and not require any special customization by specific vendors or principals.

The principal feedback function may also be customized for a specific enhanced user agent used by a specific principal. A principal 101 may turn on/turn off/adjust specific feedback options in their enhanced user agent using their own local settings.

The principal feedback function may also be customized for a specific sponsored message. A vendor may indicate the specific feedback options supported by a specific sponsored message.

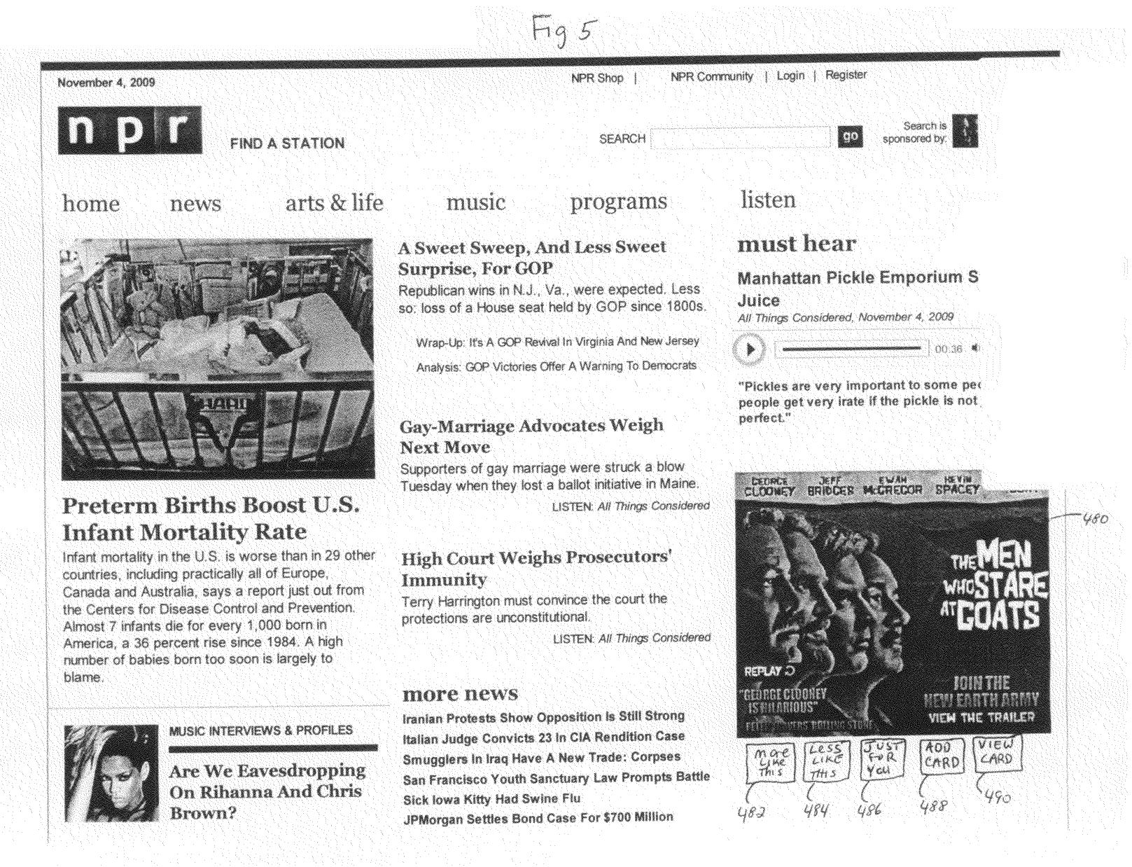

Examples of the principal feedback functions that may be associated with a sponsored message 480, FIG. 5, include a “Just for You” button 486, “More-like-this” button 482 or Less-like-this” button 484, an Add Card button 488, and a View Card button 490.

Clicking on a “Just for You” button 486 can pop up a form with options enabling a principal to customize a specific type of sponsored message. For example, if the principal receives a message about a U.S. winter ski vacation, clicking the “Just for You” button 486 produces a form where the principal can indicate the geographic area(s) they are considering, the price ranges, the size of the family or group, and their skiing ability levels. Subsequent messages can now be micro-targeted to this precise set of principal requirements.

Sponsored messages that accept a More-like-this button 482, or a Less-like-this button 484 may display two buttons. In a preferred embodiment the buttons would appear in standard colors (e.g., green for “more like this” and red for “less like this”). The principal 101 clicks the green button to indicate they would like to see more sponsored messages like this; the red button to see less. For example, if the principal is interested in new cars and receives a sponsored message about minivans, the principal can click the red button to indicate they are not interested in minivans. However if a principal is interested in Mini Coopers, the principal can click the green button when they see a sponsored message about Mini Coopers.

An “Add Card” button 488 represents the principal's interest in forming a relationship directly with the vendor publishing the sponsored message. Clicking this button will open the selector and import a card representing the set of claims the vendor would like to request from the principal and/or the principal would like to offer to the vendor in order to facilitate the relationship. For example, if a vendor's sponsored message advertises a new dry cleaning service with home pickup/delivery (which a UDAN could easily deliver only to principals living within a certain distance of the dry cleaner), the Add Card button 488 would allow a principal to obtain a card that would provide the address of the dry cleaner, enroll the principal in the home pickup program, and share the principal's home address with the vendor in as little as one click.

A “View Card” button 490 appears in place of the Add Card button 488 when the principal already has a relationship with a vendor and the sponsored message is related to that card. For example, if a principal owns a car and already has a card from the car dealer where the car was purchased, the principal may see a sponsored message for a bike rack sold from that dealer. (Such a sponsored message could be targeted very accurately in a UDAN based on the family size and children's age range.) Clicking the View Card button 490 could bring up the card and present the principal with the option to share the information necessary to: a) request more information to be sent, b) order the correct bike rack model for the principal's car immediately, or c) share this offer with a friend.

The “inversion” of conventional sponsor/ad network/site/principal relationships represented by a user directed ad network also opens new business models based on new value chains. The description below explains these value chains and the business process components that may enable them.

As discussed above, the standard revenue flow for conventional Internet advertising models is typically either Sponsor-to-Ad Network-to-site, or Sponsor-to-site. In a UDAN, the options are: 1) Sponsor-to-UDAN; 2) Sponsor-to-ad network-to-UDAN; and/or 3) Sponsor-to-UDAN-to-site.

With the first two options, the UDAN replaces the site as the final recipient in the value chain. Three options represent the much greater level of relevance and personalization a UDAN can deliver versus any specific site. With existing ad networks, however, they can still sell to the UDAN, or to particular brokers within a UDAN, the same way they sell to sites today.

The third option represents a new model in which sites still receive revenues based on the value of the content they produce, but this revenue is apportioned by a UDAN based on the value of the sponsored messages a principal 101 receives while viewing the content from the site. In this way sites who deliver high-quality content can be rewarded for the value of that content to particular principals even though: 1) The site does not need to obtain any principal profile information; and 2) The principal is receiving sponsored messages of a much higher relevance and value than it is possible for the site to deliver either working alone or in conjunction with a conventional ad network.

In other words, the site may do less work and potentially receive more revenue than with a conventional sponsor-to-site or sponsor-to-ad network-to-site model. This shift is possible by shifting control of their own advertising stream to the principal.

Certain mechanisms may enable this basic functionality. For example, when the enhanced user agent delivers to the enhanced ad server a request for a sponsored message, the request includes a site identifier (such as the website URI or page URI, or a blinded indicator protecting the principal's privacy) that the site should receive credit for the value of this sponsored message.

Also, if the principal exercises a principal feedback function with regard to the sponsored message, this may optionally further affect the computed value of the sponsored message. For example, a sponsored message that receives a “Less like this” click may be decreased in value. However a sponsored message that receives a “More like this” click, a completed “Just for You” form, or the addition of a new card may be increased in value.

The enhanced ad server and/or accounting server may also periodically produce a report aggregating data about the sponsored messages delivered and total value delivered by a site and UDAN revenues received by the broker 301 are apportioned to the site.

This mechanism may be further enhanced by providing both sites and principals with explicit opt-in control of switching to a UDAN model. For example, a site may opt-in to a UDAN model by offering its users the ability to download an enhanced user agent that is pre-configured to use the UDAN for all or a portion of the sponsored messages delivered by that site. Alternatively or additionally, a principal 101 may opt-in to using a UDAN by downloading and configuring an enhanced user agent and then “nominating” sites to begin receiving UDAN revenue based on the value of the sponsored messages the principal receives from those sites.

A particularly compelling application of this new revenue model applies to sites that are not currently able to receive advertising revenue due to neutrality requirements, referred to herein as a “neutral site”. A UDAN enables neutral sites to begin receiving “virtual advertising” income without any violation of those neutrality requirements. An example is Wikipedia.org.

Despite its position as the world's fourth most-visited site, Wikipedia is currently unable to accept advertising revenue because it would introduce bias that conflicts with Wikipedia's non-profit public education mission. The same is true of other highly prominent neutral sites that are very much in need of additional financial support, such as the U.S. National Public Radio (NPR) and Public Broadcasting System (PBS) networks.

Because a UDAN changes the normal model of sponsor/ad network/site/principal relationships, it can enable an neutral site like Wikipedia, NPR, or PBS to gain income associated with the advertising value of its pages without adversely affecting its neutrality or non-profit status because the neutral site need not be involved with the generation of this income in any way.

Following is a description of how this is enabled. First, UDAN components are configured by the appropriate party with regard to specific neutral sites to which the party wishes to donate ad revenues (“Beneficiary site”). This includes but is not limited to the following options: UDAN Beneficiary Sites, Broker Beneficiary Sites, and/or Principal Beneficiary Sites.

UDAN Beneficiary Sites are sites preferably designated for support at a network-wide level. This means that all enhanced user agents distributed by brokers in the UDAN would be configured by default to request sponsored messages when a principal visits a UDAN Beneficiary site. In a preferred embodiment the principal can override this selection and turn off delivery of sponsored messages from a UDAN Beneficiary site (“opt-out”).

Broker Beneficiary Sites are sites designated for support at the broker level. This means enhanced user agents distributed or served by that broker would by default deliver sponsored messages when a principal visits a broker beneficiary site. Again, in a preferred embodiment the principal can override this selection and opt-out of delivery of sponsored messages from a broker beneficiary site.

Principal Beneficiary Sites are sites designated for support directly by the principal, i.e., the principal “opts-in”. One advantage of principal-selected beneficiary sites is that it permits extremely fine-grained targeting. For example, a principal could opt-in to his/her favorite blogs becoming principal 101 beneficiary sites. (However this may also create a harmful cross-incentive-see the section on Gaming below.)

Secondly, the principal visits a beneficiary site. The enhanced user agent compares the site URI against an enhanced ad server (or in a preferred embodiment a special index on that server, or a separate indexing server, or a local cache of this index), to determine if the site URI represents a beneficiary site. If so, unless the principal has opted-out of this beneficiary site, the enhanced user agent delivers a sponsored message following the normal UDAN accounting procedure described above.

An important feature of an enhanced user agent is that when neutral sites do not currently allocate any web page real estate to advertising, the enhanced user agent can be configured to automatically display sponsored messages in a standard location or frame, such as a top, side, or bottom frame, or in a “floater” that appears above some portion of page content. The location of this space may be statically or dynamically configured by the principal on a global basis, a per-site basis, or as otherwise determined by principal rules.

At the conclusion of a reporting period, reports on sponsored messages delivered to beneficiary sites are compiled from the enhanced ad servers or accounting servers. Revenue apportionable to beneficiary sites is then contributed to the beneficiary sites in a manner appropriate to their legal and corporate status. For example, the revenue apportionable to Wikipedia could be donated to Wikipedia by the UDAN, by individual brokers, or by individual principals as best suits the mechanics and tax requirements of the respective parties.

In addition to the new business models described above, another option for a UDAN is to make payments directly to the principals for the value of their attention to sponsored messages. This can enabled with the same components and processes described above; the only difference is that the principal 101 becomes an additional beneficiary (or the only beneficiary).

The principal's legal ability to be paid for their attention to sponsored messages may be verified using of a third-party card. In a preferred embodiment such a card is obtained from an issuing party 401 such as a bank or credit reporting firm that is able to verify the principal's legal identity and qualifications to participate in such a program. Such verification may use Knowledge-Based Authentication (KBA) as described above, or it may use other equivalent real-world identity authentication and attribute verification schemes.

However it is questionable whether direct payments to principals for the value of their attention stream is effective due to the cross-incentives this form of reward introduces, especially in comparison to other non-cash incentives vendors may offer that do not have such cross-incentives, such as increased relevance and personalization, better customer service, and more effectively targeted offers such as discounts or loyalty programs.

Incentives for gaming the system are present in any system that offers increased benefits to principals in exchange for increased participation. For example, both the ability for a principal to opt-in to principal beneficiary sites and the ability for principals to be paid directly for attention to sponsored messages as described above can invite gaming. In the former case, a principal or a group of principals may conspire to reprogram or robotically control a population of enhanced user agents to view web pages from the principal beneficiary site in order to artificially drive revenue to a principal beneficiary site. In the latter case a principal might reprogram or robotically control their own set of enhanced user agents in order to be paid for “viewing” sponsored messages.

Merely verifying a principal's legal identity through knowledge based authentication or other means does not by itself prevent gaming of a UDAN. However a UDAN, working in conjunction with a brokered information sharing system 100, does offer the ability to prevent the most common form of gaming in online networks, the Sybil Attack. This is the name given to a system in which an attacker can create an unbounded number of identities in order to overwhelm protections within the system.

A UDAN can prevent Sybil attacks if brokers use KBA or an equivalent form of authentication that strongly establishes the real-world identity of the principal 101 without requiring that unique identity to be revealed to any third party (or even to the broker 301). Armed with this ability to accurately determine whether a principal is unique on the UDAN, and to strongly associate each enhanced user agent with such a unique principal, brokers can employ a simply anti-gaming algorithm that monitors: The set of selectors and enhanced user agents registered to any one unique principal 101, and/or the volume of sponsored messages delivered by a Beneficiary site to the set of enhanced user agents.

Provided both are within reasonable limits, gaming is either not present or minimal. Activity outside these limits would trigger fraud detection and could automatically disqualify the principal 101 from receiving payments directly or being included in the revenue calculations of payments to Beneficiary sites.

In addition to a fixed pricing model, a UDAN may also employ an auction model for pricing of sponsored messages similar to the AdWords and AdSense models. However, this model may differ from AdWords or AdSense in several novel ways. For example, auction bidding may be keyed to keywords or key topics reflecting specific intentions of the principal 101 as expressed via wish cards. For example, a vendor may bid on delivering a sponsored message to any principal who has a wish card for “video game” or “Playstation”. This has much more powerful and directed semantics than merely doing a web search for those terms.

Auction bidding may be keyed to specific brand or vendor preferences expressed via principal profile card. For example, a vendor may bid on delivering a sponsored message to any principal who has expressed a vendor preference for “Sony”, “Nintendo”, or both. Even higher value may be ascribed if the vendor preference is expressed in the context of the category “Video Games”.

Auction bidding may be keyed to any other set of profile elements from the principal profile information available via an enhanced ad server. For example, a vendor may bid on delivering a sponsored message to a male between the ages of 13 and 16 who owns a Nintendo Wii.

A feedback loop may be implemented between the principal profile information entered by principals and the principal profile card attributes being requested by vendors. For example, a vendor of video games may develop a principal profile card specific for teenage video game players. The vendor may use the UDAN to advertise the availability of this principal profile card and offer discounts or other incentives to principals who fill out the card. Once filled out, this principal profile information can be used either identifiably or anonymously to direct further sponsored messages from the vendor to qualified principals. These sponsored messages may in turn offer even more detailed principal profile cards to principals with particular interests (for example, using the “Add Card” feedback option described above). For example, a Playstation gamer could be offered a principal profile card for Playstation owners, while a Wii gamer could be offered a principal profile card for Wii owners. As a more complete profile is developed, the auction value of the ability to send a sponsored message to a principal meeting detailed profile characteristics rises.

A feedback loop may also be implemented directly between a principal (or the enhanced user agent acting on the principal's behalf) and the enhanced ad server to return information about the relative value of different elements of principal profile information. For example, a principal may be able to learn that the value of their video gaming profile doubles if they add their existing video gaming devices to their principal profile information, and that it doubles again if they add their existing games and game preferences. Of course if vendors offer incentives for principals to enter this information, this can lead to gaming of the system, however the ability for third-party cards to provide independent verification of certain principal characteristics and relationships as described above may offset this risk.

In a UDAN, there is a strong need for principals and vendors to share a common vocabulary with regard to both principal profile information (obtained through principal profile cards and wish cards) and sponsored message profiles. This shared vocabulary is necessary so that enhanced ad servers can apply efficient and effectives matching algorithms.

In a large and dynamic UDAN, a controlled vocabulary may not be flexible enough to adapt at the speed that principals and vendors are evolving. At the same time, reliance on natural language vocabulary alone can be equally problematic due to lack of precision and difficulty in performing machine matches with a high degree of accuracy.

A solution is the use of a machine-assisted dictionary and suggestion service, referred to herein as a “dictionary service”. Similar to the function of a spellchecker for word processing software, a dictionary service attempts to match natural language text entries to dictionary entries in order to verify whether the semantics intended by the principal 101 are represented in the dictionary or not. If so, the principal can proceed with confidence that the semantics are understood. If not, the principal is typically presented with two choices: Correct the natural language text to conform to the dictionary; and/or 2) Add the new term(s) to the dictionary to expand its vocabulary.

This dictionary service may be incorporated into the operation of a UDAN. The authors of principal profile cards (be they vendors or principals) use a schema definition program, referred to herein as an “authoring program”) to create the schema for a principal profile card. This schema consists of the set of XDI subject, predicate, and object choices available, referred to herein as a “card schema element”. Just as a spellchecker can be used to spellcheck a word processing document interactively (writing mode), or in post-production (review mode), the authoring program can check each selection of a card schema element interactively (as the card schema is being created), or in post-production (after the card schema is complete).

Like most spellcheckers, when the authoring program does not find a match, it can ask the author if they wish to: a) choose a term from the suggestions offered by the dictionary (based on the closest match(es) the dictionary service can find), b) search for a different term in the dictionary, or c) add the new term to the dictionary.

In a preferred embodiment a principal 101 is also able to use the enhanced user agent as an authoring program. This allows a principal 101 to create a principal profile card or extend another author's principal profile card (if the card author permits). In this case the same set of options described in the previous paragraph is presented to the principal 101 during or after card editing.

The result is constant, real-time harmonization and extension of the dictionary shared by the community of principals and the community of vendors so the same card schema elements can be used for both principal profile information and sponsored message profiles, and matching by enhanced ad servers can be highly precise and efficient.

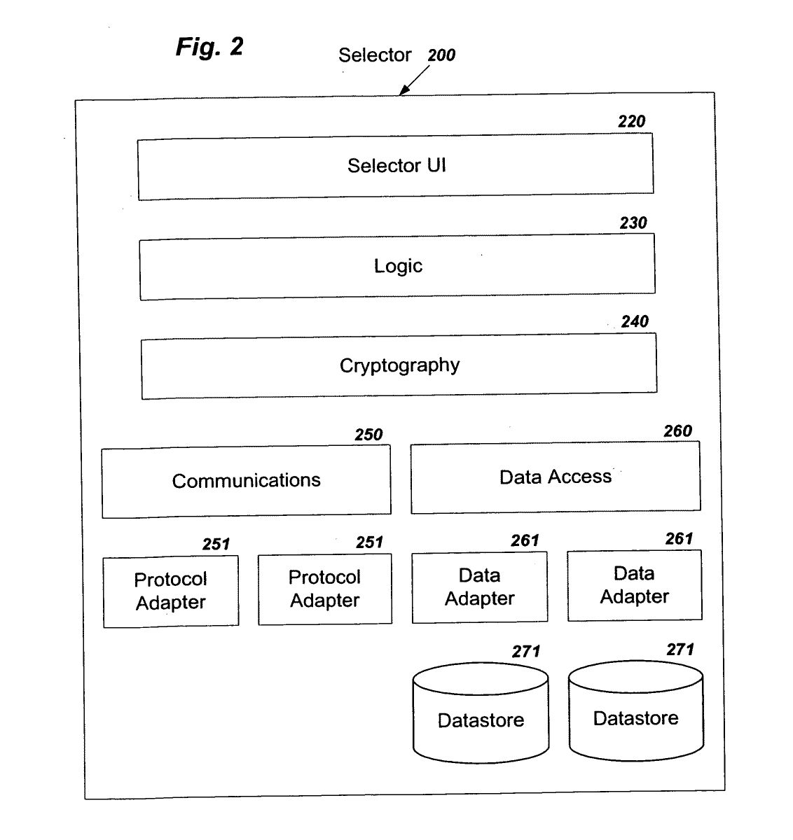

A typical selector program 200, FIG. 2, includes selector UI (user interface) module 220, logic module 230, cryptography module 240, communications module 250, data access module 260, protocol adapters 251, data adapters 261, and datastores 271.

Selector UI module 220 is responsible for displaying screens, menus, cards, data, and information sharing relationships to the principal and accepting input from the principal to control and manage the principal's information. Selector logic module 230 is where the processing logic of the selector is executed to trigger the display of screens, sending of messages, reading/writing of data, or performance of other actions needed to carry out the functions of the selector.

Selector cryptography module 240 is called by other modules when data encryption, decryption, verification, and other cryptographic services are required. With respect to the generation and transformation of security tokens such as those related to cards in protocols such as WS-Trust, this module is sometimes referred to as a “security token service” or “STS”. The current WS-Trust V1.3 specification, published by the OASIS Web Services Secure Exchange Technical Committee, is available at the link http://docs.oasis-open.org/ws-sx/ws-trust/200512/ws-trust-1.3-os.html. In a preferred embodiment, cryptography module 240 is configured to communicate securely with a similar security module that is part of the operating system of the device, such as the Microsoft Cryptograph API (MSCAPI) in the Microsoft Windows® operating system. Such security can be further hardened by use of a trusted hardware security module such as the Trusted Platform Module whose specifications are defined by the Trusted Computing Group at https://www.trustedcomputinggroup.org/specs/TPM/.

Selector communications module 250 is called by other modules to send and receive messages that need to be delivered over communications protocols relevant to the selector's functions. In a preferred embodiment, the communications module performs these functions by calling protocol modules 251 that handle the specific details of particular communications protocols. Besides WS-Trust, the example embodiments discussed herein may involve the HTTP, HTTPS, and XDI protocols. The HTTP protocol specification, published as RFC 2616 by the Internet Engineering Task Force (IETF), is available at http://tools.ietf.org/html/rfc2616. The HTTPS protocol, published as IETF RFC 2818, is available at http://tools.ietf.org/html/rfc2818. The XDI protocol, published of the OASIS XRI Data Interchange (XDI) Technical Committee, is a work-in-progress described in the aforementioned “The XDI RDF Model”. However in a preferred embodiment, brokered information sharing system 100 is extensible to support any type of protocol that may be used to transfer data, credentials, tokens, or cards.

Selector data access module 260 is called when the selector needs to read or write data from local datastores. In a preferred embodiment, the selector uses a data abstraction layer in which data access module 260 calls different data adapters 261 to read/write data from any type of datastore 271. Such a data abstraction layer is provided by the open source Higgins Project, a project of the Eclipse Foundation available at http://www.eclipse.org/higgins/. This data abstraction layer may be used on either clients and servers to make data available via a uniform API (application programming interface) and data model called the Context Data Model (CDM). On a client device, such a data abstraction layer enables a selector to read and write data from local datastores such as the Linux, Apple Macintosh®, or Microsoft Windows® file systems; local directories system such as the Windows Registry; local applications such as Mozilla Thunderbird, Microsoft Outlook®, or Microsoft Excel®; or local databases such as MySQL or Microsoft Access®. Such datastores may use application-specific data schemas, or they may use a context-independent schema such as the RDF (Resource Description Framework) defined by the World Wide Web Consortium's Semantic Web activity (http://en.wikipedia.org/wiki/Semantic_Web) or the XDI RDF model defined by the OASIS XDI Technical Committee. In particular the aforementioned document “The XDI RDF Model” specifies a compact serialization format for XDI RDF documents called X3. Several X3 variants are specified for different purposes: X3 Standard for compact over-the-wire transmissions; X3 Whitespace for human-readable display; and X3 Simple for human-readable/writeable display. The example XDI RDF documents disclosed herein use the X3 Simple format. In such example documents, all values enclosed in squiggly brackets, e.g., {selector-i-number}, are placeholders for the actual values used in real instances. In a preferred embodiment selector 200 is integrated with a principal's Internet browser and with other communications software that may run on a device such as an email client, instant messaging client, VoIP client, etc. Selector 200 can operate entirely as a plug-in module, or as a combination of a plug-in and a standalone program, or entirely as a standalone program, or any combination as best suits the operating system, security requirements, and user preferences.

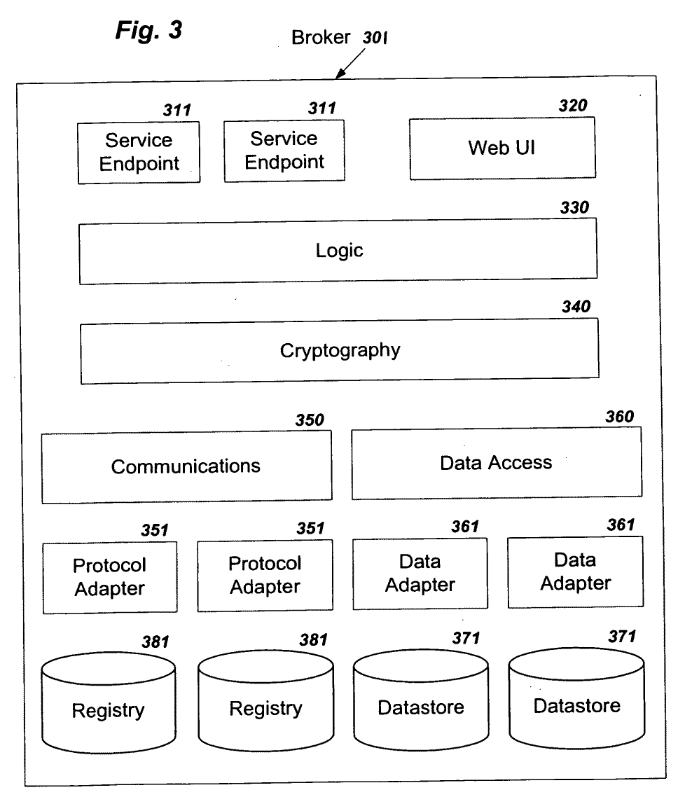

Broker subsystem 301, FIG. 3, typically includes service endpoints 311, web UI module 320, logic module 330, cryptography module 340, communications module 350, data access module 360, protocol adapters 351, data adapters 361, datastores 371, and registries 381. All of these modules perform substantially the same functions as the corresponding modules in selector 200 with the exception of service endpoints 311, the web UI 320, and the registries 381.

Service endpoints 311 are the server-side complement of protocol adapters 251 in FIG. 2. They handle protocol messages received by broker 301, FIG. 3, route them to other modules as required for processing, and send the corresponding response as required. The network location and any other essential communications characteristics of a service endpoint are described in a discovery document accessible via a discovery protocol used by components of brokered information sharing system 100 as further described herein.

Web UI module 320 is responsible for display of web pages that provide a browser-accessible user interface for the broker. The present invention is not limited to a web UI; a client-server UI or any form of UI that provides principals with direct access to the functions of a broker when required could also be implemented. The broker UI is not a limiting feature of the invention.

Registries 381 are a specialized form of datastore optimized for storage and indexing of identifiers and discovery metadata describing principals and other parties in system 100. Such registries may be implemented under a data abstraction layer, such as Higgins as described above, or they may be implemented separately. Such identifiers may be an OpenID identifier as defined by the OpenID Authentication 2.0 specification published by the OpenID Foundation, available at http://openid.net/specs/openid-authentication-2_{—}0.html. OpenID identifiers include URIs conforming to the URI specification, published by the IETF as RFC 3986 available at http://tools.ietf.org/html/rfc3986, and XRIs conforming to the aforementioned “XRI Syntax V2.0” specification published by the OASIS XRI Technical Committee, or any other form of identifier which provides the identification and discovery properties required of brokered information sharing system 100 as described herein. Such discovery metadata may include data elements defined for XRDS discovery documents as defined by the aforementioned “XRI Resolution V2.0” specification published by the OASIS XRI Technical Committee, SAML metadata documents as defined by the “Metadata for the OASIS Security Assertion Markup Language (SAML) V2.0” specification published by the OASIS Security Services Technical Committee at http://docs.oasis-open.org/security/saml/v2.0/saml-metadata-2.0-os.pdf, WS-SecurityPolicy documents as defined by the “WS-SecurityPolicy V1.2” specification published by the OASIS Web Services Secure Exchange Technical Committee available at http://docs.oasis-open.org/ws-sx/ws-securitypolicy/200702/ws-securitypolicy-1.2-spec-os.html, or any other discovery or metadata exchange protocol that may be integrated into brokered information sharing system 100. In a preferred embodiment XRIs are used with XRI trusted resolution to retrieve XRDS documents.

The use of data access module 360 and, in a preferred embodiment, a data abstraction layer, such as Higgins can be employed by a broker to provide access to different back-end datastores such as LDAP directories, relational or object-oriented databases, in-memory databases, data warehouses, or other data repositories as needed to meet the broker's requirements for security, performance, reliability, scalability, and storage of different data types.

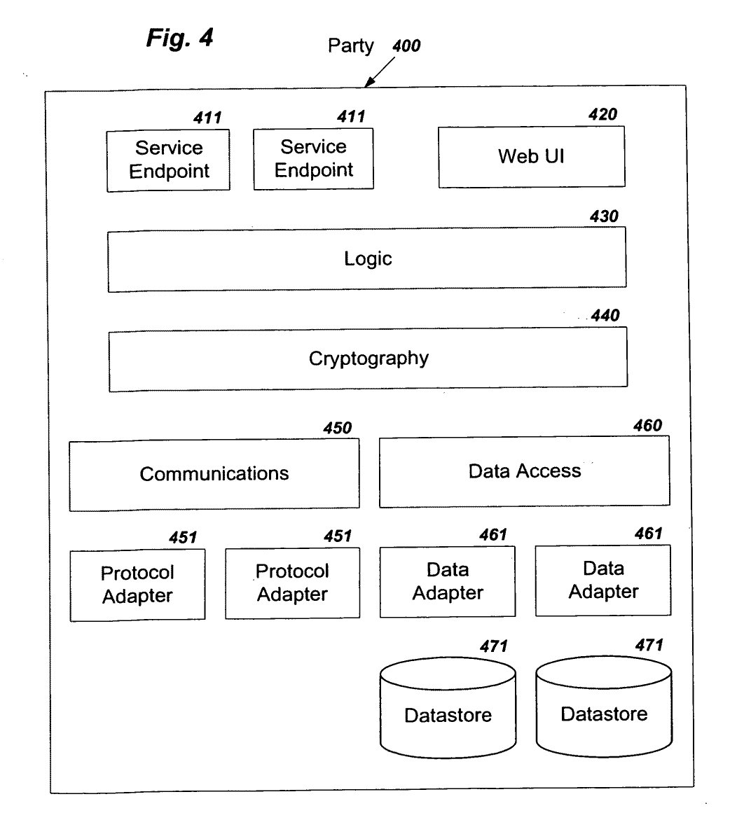

An example of party 400, FIG. 4, includes service endpoints 411, web UI module 420, logic module 430, cryptography module 440, communications module 450, data access module 460, protocol adapters 451, data adapters 461, and datastores 471. All of these modules perform substantially the same functions relative to a party as the corresponding modules in broker 301 with the exception that a party may not need registry 381.

Although they serve different roles, the basic components of party 400 are typically the same for both issuing parties 401 and relying parties 402.

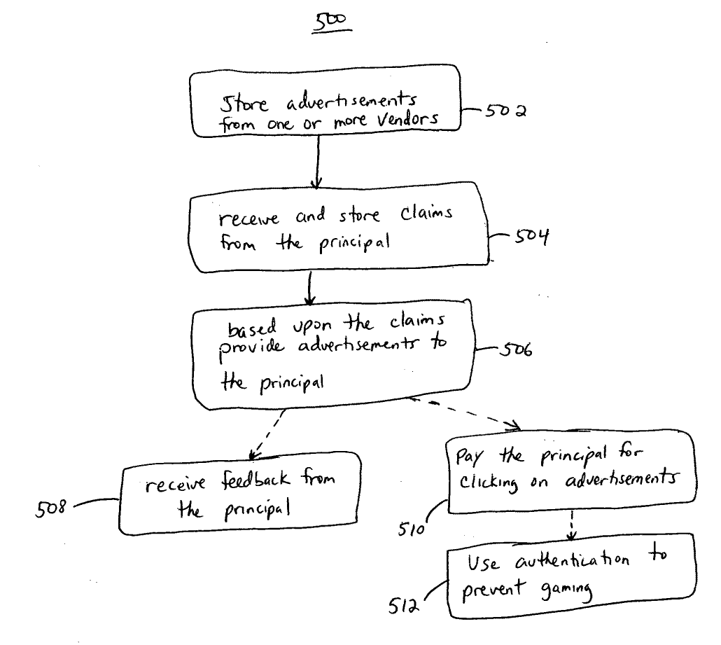

FIG. 6 is a diagram depicting the primary steps of a method 500 associated with directing advertisements to a user over a network. At 502, a broker stores advertisements from one or more vendors. The advertisements may be stored at the site of the broker, or may be stored remotely at a site of an agent. At 504, the broker receives and stores claims from a principal that include information of the advertisement preferences of the principal. These claims may be located on one or more cards or may be in the form of rules provided by the principal. Based upon the information in the claims, at 506, the broker provides to the principal over the network advertisements that relate to the preferences of the principal.

Method 500 may include additional steps such as receiving feedback 508 from the principal regarding the types of advertisement that the principal would like to receive. This allows the broker to optimize the types of advertisements that are provided to the principal. At 510, the broker may also pay the principal or clicking on advertisements. In this case, at 512 the broker may use knowledge based authentication (KBA) to prevent gaming of the advertisement network.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A user directed advertisement network comprising:
an ad server having a database for storing advertisements from one or more vendors;
a broker configured with software to receive and store claims including information of one or more advertisement preferences of a principal, and, based upon at least one claim, to provide to the principal one or more advertisements stored on the ad server that relate to the preferences of the principal; and
an agent used by the principal and configured with software to provide the claims including the information of the advertisement preferences to the broker, and to receive and display the advertisements from the broker.

2. The network of claim 1 in which the claims having information relating to the advertisement preferences of a principal are held by one or more cards.

3. The network of claim 1 in which the claims include rules relating to the advertisement preferences of a principal.

4. The network of claim 1 in which the agent includes a selector.

5. The network of claim 4 in which the agent includes a browser extension program that runs on the selector.

6. The network of claim 1 in which the agent includes a program that is an extension to another local program.

7. The network of claim 1 in which the agent includes a standalone client-side program.

8. The network of claim 1 in which a third-party also provides one or more cards that include information of advertisement preferences of the principal to the broker.

9. The network of claim 1 in which the information of the advertisement preferences of the principal includes information about the principal.

10. The network of claim 1 in which the information of the advertisement preferences of the principal includes specific products or services from a wishlist of the principal.

11. The network of claim 1 further including an accounting server for tracking the number of times a principal clicks on an advertisement of a vendor.

12. The network of claim 11 in which the principal is paid for clicking on advertisements.

13. The network of claim 12 in which the broker authenticates the user to prevent gaming of the advertisement network.

14. The network of claim 1 in which the broker receives feedback from the principal regarding the types of advertisement that the principal would like to receive.

15. The network of claim 14 in which the feedback includes information that the principal would like to receive more advertisements like an advertisement that the principal has already received.

16. The network of claim 14 in which the feedback includes an indication that the principal would like to receive more specific information about an advertisement.

17. The network of claim 14 in which the feedback includes an indication that the principal would like to enter into a relationship directly with the vendor of a specific advertisement.

18. The network of claim 17 in which the feedback includes an indication that the principal would like more specific information from the vendor.

19. The network of claim 1 in which the agent communicates with the ad server via an XDI communications protocol.

20. The network of claim 1 in which the user directed advertisement network receives the revenue from displaying the advertisements and the website that displays the advertisement does not receive any revenue from the advertisement.

21. The network of claim 1 in which the user directed advertisement network uses an auction for the pricing of advertisements.

22. The network of claim 1 in which the broker is configured to use a dictionary service to provide a common vocabulary between the information of the advertisement preferences of the principal and information about the advertisements.

23. The network of claim 1 in which the broker provides advertisements to the principal further based upon a current context of the principal.

24. The network of claim 23 in which the current context is a current web page that the principal is browsing.

25. The network of claim 23 in which the current context is a current time.

26. The network of claim 23 in which the current context is a current weather.

27. The network of claim 23 in which the broker provides advertisements to the principal further based upon the inventory of advertisements stored on the ad server.

28. The network of claim 1 in which the broker is provided by a web service.

29. The network of claim 1 in which the broker is co-resident with the user agent.

30. A method for directing advertisements to a user over a network, the method comprising:
storing advertisements from one or more vendors;
receiving and storing claims including information of one or more advertisement preferences of a principal; and
based upon at least one claim, providing to the principal over the network advertisements that relate to the preferences of the principal.

31. The method of claim 30 further including receiving feedback from the principal regarding the types of advertisement that the principal would like to receive.

32. The method of claim 30 further including tracking the number of times a principal clicks on an advertisement of a vendor.

33. The method of claim 30 further including paying the principal for clicking on advertisements.

34. The method of claim 30 further including using knowledge based authentication (KBA) to prevent gaming of the advertisement network.

35. The method of claim 30 in which the claims include one more cards each having information of the advertisement preferences of a principal.

36. The method of claim 30 in which the claims include one or more rules relating to advertisement preferences of a principal.

37. The method of claim 30 in which providing advertisements to the principal is further based upon a current context of the principal.

38. The method of claim 37 in which the current context is a current web page that the principal is browsing.

39. The method of claim 37 in which the current context is a current time.

40. The method of claim 37 in which the current context is a current weather.

41. The method of claim 37 in which providing advertisements to the principal is further based upon the inventory of advertisements.

42. A user directed advertisement network comprising:
means for storing advertisements from one or more vendors;
a broker configured with software to receive and store claims including information of one or more advertisement preferences of a principal, and to provide to the principal one or more advertisements stored on the ad server that relate to the preferences of the principal; and
means used by the principal and configured with software to provide the claims including the information of the advertisement preferences to the broker, and to receive the advertisements from the broker.

43. The network of claim 42 in which the claims having information relating to the advertisement preferences of a principal are held by one or more cards.

44. The network of claim 42 in which the claims include rules relating to the advertisement preferences of a principal.

45. A method for directing advertisements to a user over a network, the method comprising:
configuring a broker with software to receive and store claims including information of one or more advertisement preferences of a principal, and to provide to the principal one or more advertisements stored on an ad server that relate to the preferences of the principal; and
configuring an agent used by the principal with software to provide the claims including the information of the advertisement preferences to the broker, and to receive the advertisements from the broker.

46. The method of claim 45 in which the claims having information relating to the advertisement preferences of a principal are held by one or more cards.

47. The method of claim 45 in which the claims include rules relating to the advertisement preferences of a principal.
